(19) United States
(12) Patent Application Publication
(10) Pub. No.: US 2024/0407307 A1
(43) Pub. Date: Dec. 12, 2024

(54) THERMALLY CONTROLLED PLANT NURSERY ASSEMBLY

(71) Applicant: Gaylon Taylor, Rosenberg, TX (US)

(72) Inventor: Gaylon Taylor, Rosenberg, TX (US)

(21) Appl. No.: 18/206,891

(22) Filed: Jun. 7, 2023

(51) Int. Cl. A01G 9/14; A01G 9/24

(52) U.S. Cl. CPC A01G 9/14; A01G 9/246; A01G 9/247; A01G 2009/1492

(57) ABSTRACT

A thermally controlled plant nursery assembly for growing plants in a cooled environment includes a housing enclosing an interior space and including a bottom wall, a top wall, and a perimeter wall extending between the bottom wall and the top wall. A plurality of containers is removably stored within the interior space of the housing and each container of the plurality of containers receives soil for a plant. A thermal control system cools each container to facilitate growing the plant of each container in a cooled environment. A circuit board is electrically coupled to the thermal control system and an actuator is electrically coupled to the circuit board. A plurality of fans facilitates the cooling of the each container of the plurality of containers by circulating cooled air. A water supply system supplies water to the soil of each container. A sanitizer is actuated to disinfected the interior space of the housing.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to nurseries and more particularly pertains to a new nursery for growing plants in a cooled environment. (2) DESCRIPTION OF RELATED ART INCLUDING INFORMATION DISCLOSED UNDER 37 CFR 1.97 AND 1.98

The prior art relates to nurseries and includes a variety of nurseries enclosing an interior space to control an environment for growing plants. Known prior art does not include a nursery having a thermal control system and a water supply system being in thermal communication and fluid communication respectively and having a sanitizer to disinfect the interior space storing the container.

### (h) BRIEF SUMMARY OF THE INVENTION

An embodiment of the disclosure meets the needs presented above by generally comprising a housing enclosing an interior space and including a bottom wall, a top wall, and a perimeter wall extending between the bottom wall and the top wall. A plurality of containers is removably stored within the interior space of the housing and each container of the plurality of containers is configured for removably receiving soil for a plant. A thermal control system is in thermal communication with each of the containers. The thermal control system cools each container to facilitate growing the plant of each container in a cooled environment. A circuit board is electrically coupled to the thermal control system and an actuator is electrically coupled to the circuit board and is engageable by a user to actuate the thermal control system. A plurality of fans is electrically coupled to the circuit board and facilitates the cooling of each container of the plurality of containers by circulating cooled air. A water supply system is in fluid communication with the plurality of containers, wherein the water supply system supplies water to the soil of each container. A sanitizer is electrically coupled to the circuit board and is actuated to disinfect the interior space of the housing. A power supply is electrically coupled to the circuit board. A plurality of wheels is mounted to the bottom wall of the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric detail view of a thermally controlled plant nursery assembly according to an embodiment of the disclosure.

FIG. 2 is a front exploded view of an embodiment of the disclosure.

FIG. 3 is a front view of an embodiment of the disclosure.

FIG. 4 is a side view of an embodiment of the disclosure.

FIG. 5 is a cross-sectional view of an embodiment of the disclosure taken along Line 5-5 of FIG. 4.

FIG. 6 is a cross-sectional view of an embodiment of the disclosure taken along Line 6-6 of FIG. 3.

FIG. 7 is a box diagram view of an embodiment of the disclosure.

### (j) DETAILED DESCRIPTION OF THE INVENTION

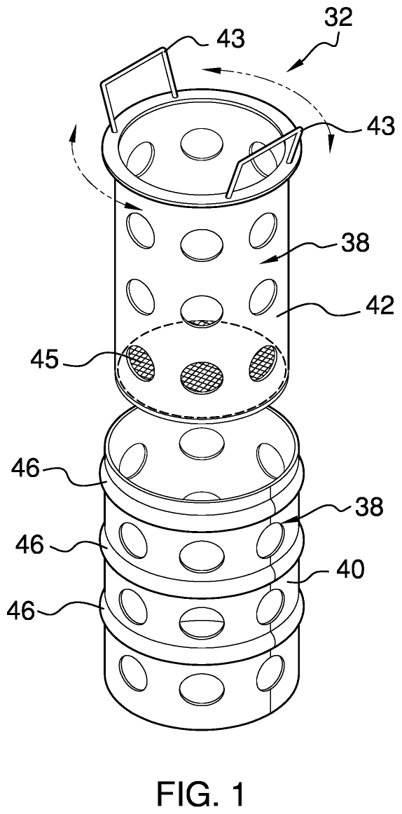

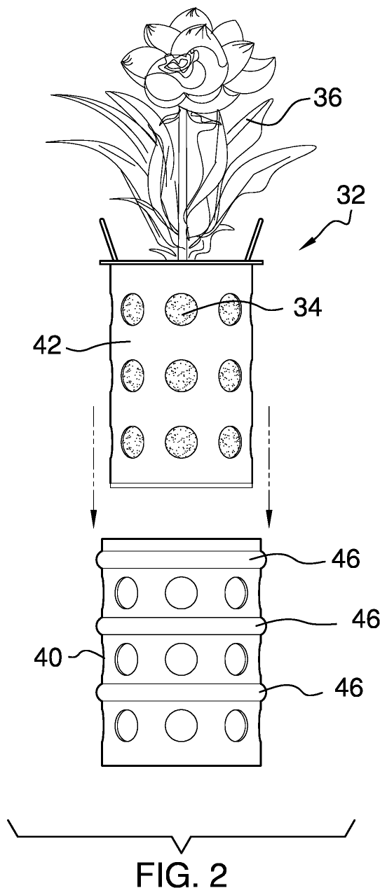

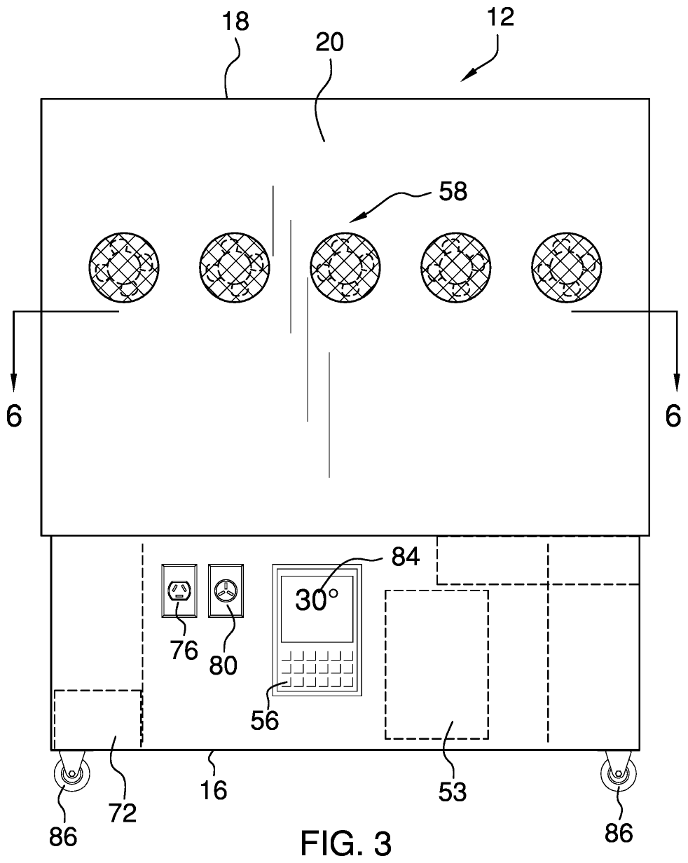

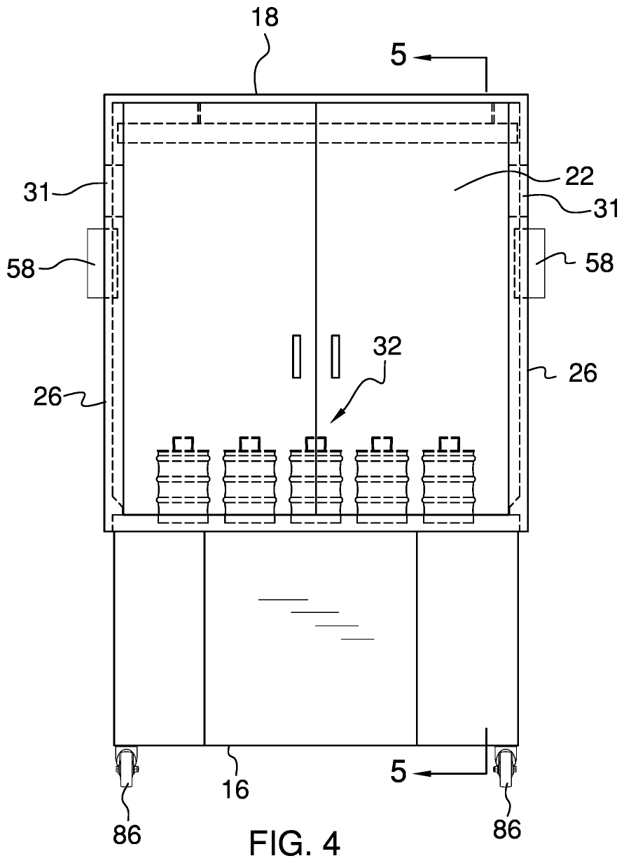

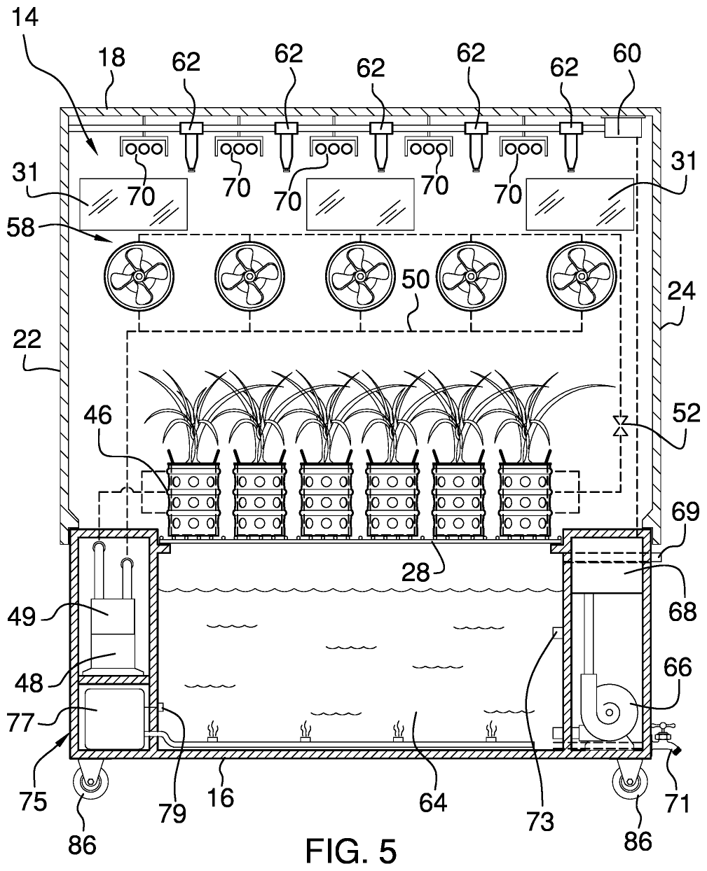

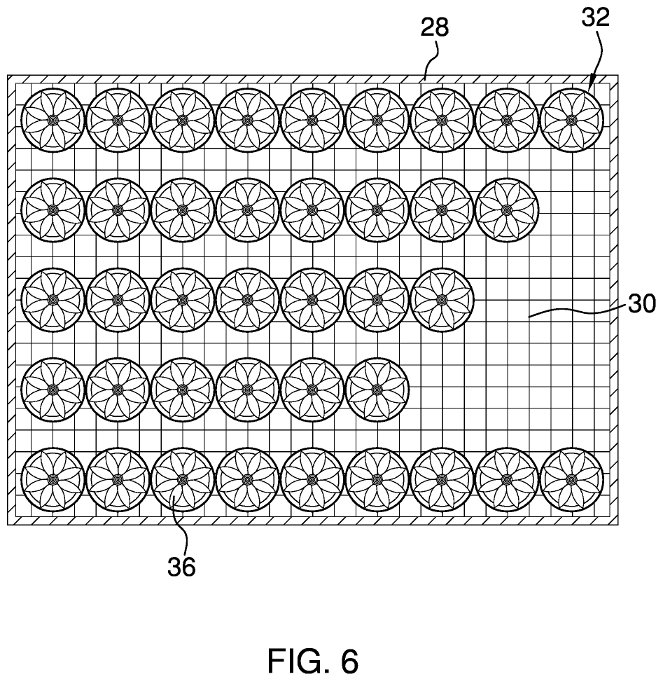

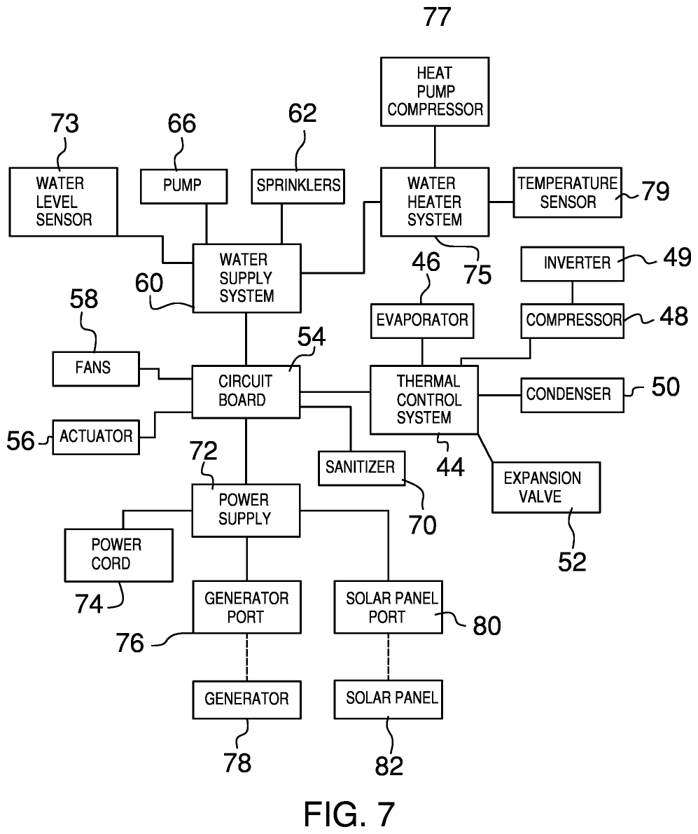

With reference now to the drawings, and in particular to FIGS. 1 through 7 thereof, a new nursery embodying the principles and concepts of an embodiment of the disclosure and generally designated by the reference numeral 10 will be described.

As best illustrated in FIGS. 1 through 7, the thermally controlled plant nursery assembly 10 generally comprises a housing 12 enclosing an interior space 14 and including a bottom wall 16, a top wall 18, and a perimeter wall 20 extending between the bottom wall 16 and the top wall 18. The perimeter wall 20 normally includes a first wall 22, a second wall 24, and a pair of side walls 26. The first wall 22 may include a door for accessing the interior space 14. A shelf 28 may be spaced between the top 18 and bottom 16 walls and may be positioned lateral relative to the housing 12. The shelf 28 is perforated with a plurality of holes 30 to allow water to pass therethrough. Each of the side walls 26 may have window openings 31 extending therethrough. Each of the window openings 31 has a glass pane closing the window opening 31. A shading layer may be positioned on the glass pane of each of the window openings 31 to inhibit excessive sunlight through each of the window openings 31.

A plurality of containers 32 is removably stored within the interior space 14 of the housing 12 and is normally positioned on the shelf 28 of the housing 12. Each container 32 of the plurality of containers 32 is configured for removably receiving soil 34 for a plant 36. The plant 36 is typically configured to grow in cooled environments, such as coffee plants. Each container 32 is perforated with a plurality of apertures 38 for allowing fluid to pass through each container 32, wherein each container 32 does not overflow with water. Each container 32 normally includes an exterior tube 40 and an interior bucket 42 being removably nested within the exterior tube 40. The interior bucket 42 of each container 32 may include a pair of handles 43 to facilitate removing the interior bucket 42 from the exterior tube 40. The bottom 45 of each interior bucket 42 typically will comprise a mesh material to provide an outlet for water wherein the bottom 45 of each interior bucket 42 prevents overfilling each container 32 with water. The interior bucket 42 is rotatable within the exterior tube 40 such that each of the apertures 38 of the interior bucket 42 may axially align with a respective one of the plurality of apertures 38 of the exterior tube 40 to allow extra air to the soil 34.

A thermal control system 44 is in thermal communication with each of the containers 32. The thermal control system 44 cools each container 32 to facilitate growing the plant 36 of each container 32 in a cooled environment. The thermal control system 44 typically includes an evaporator 46 comprising a plurality of cooling coils and may be coupled to the exterior tube 40 of each container 32. The cooling coils contain a refrigerant being a cooled gas, wherein the refrigerant absorbs heat from each container 32. A compressor 48 is fluidly coupled to the cooling coils of the evaporator 46 and receives the refrigerant from the cooling coils to compress the refrigerant into a liquid state. An inverter 49 is electrically coupled to the compressor 48 to control the speed of the compressor 48. The compressor 48 may be mounted on the bottom wall 16 within the interior space 14 of the housing 12. A condenser 50 is fluidly coupled to the compressor 48 and receives the refrigerant from the compressor 48 to cool the refrigerant into a cooled liquid. The condenser 50 normally comprises a plurality of condenser 50 coils and is mounted to an exterior of the housing 12. An expansion valve 52 is fluidly coupled to the condenser 50 and to the evaporator 46. The expansion valve 52 receives the refrigerant from the condenser 50 and expands the refrigerant into a gas state to absorb heat. The thermal control system 44 may also include a propane tank 53 to supply natural gas to the containers 32, wherein the soil 34 is able to receive natural gas from the propane tank 44 when needed.

A circuit board 54 is electrically coupled to the thermal control system 44 and an actuator 56 is electrically coupled to the circuit board 54 and is engageable by a user to actuate the thermal control system 44. The actuator 56 normally comprises a display screen. The display screen may be touch screen, or the display screen can have a plurality of switches positioned proximate thereto. A plurality of fans 58 is electrically coupled to the circuit board 54. The fans 58 facilitate the cooling of the each container 32 of the plurality of containers 32 by circulating cooled air. Each side wall 26 of the pair of side walls 26 has at least one of the fans 58 attached thereto. The fans 58 may be in fluid communication with the thermal control system 44 such that the fans 58 provide cooled air to the thermal control system 44 to remove heat.

A water supply system 60 is in fluid communication with the plurality of containers 32, wherein the water supply system 60 supplies water to the soil 34 of each container 32. The water supply system 60 includes a plurality of sprinklers 62 providing water downwardly to the containers 32 to facilitate growing of the plants. The sprinklers 62 are coupled to the top wall 18 of the housing 12 and emit misty water over the containers 32. Each of the containers 32 and the shelf 28 are perforated to allow water to pass into a reservoir 64 positioned between the bottom wall 16 and the shelf 28 of the housing 12. A pump 66 is electrically coupled to the circuit board 54 and is fluidly coupled to the reservoir 64 and to the sprinklers 62, wherein the pump 66 is actuated to bring water from the reservoir 64 to the sprinklers 62. The pump 66 is normally mounted to the bottom wall 16 within the housing 12. A filter 68 is coupled to the pump 66 and filters the water from the pump 66.

A water inlet 69 is positioned on the second wall 24 of the housing above the reservoir 64 and a water outlet 71 is positioned on the second wall 24 below the reservoir 64. The water inlet 69 and the water outlet 71 each are in fluid communication with the reservoir 64. The reservoir 64 is refillable with water by connecting a hose from a water supply to the water inlet 69. A water level sensor 73 may be positioned within the reservoir and automatically turn on the water supply when the water in the reservoir 64 is below the water level sensor 73, wherein the water supply will refill the reservoir 64 automatically. Water is removable from the reservoir by opening the water outlet 71 to drain out the water from the reservoir 64.

A water heater system 75 is in fluid communication with the water supply system 60. The water heater system includes a heat pump compressor 77 that heats water by emitting heated air into the reservoir 64. The water heater system 75 includes a temperature sensor 79 that records the temperature of the water contained in the reservoir 64. The water heater system 75 is electrically coupled to the actuator 56, wherein the water heater system 75 is controllable by the user when engaging with the actuator 56.

A sanitizer 70 is electrically coupled to the circuit board 54 and is actuated to disinfect the interior space 14 of the housing 12. The sanitizer 70 normally comprises a plurality of ultra-violet light emitters emitting ultra-violet light when actuated. The sanitizer 70 is coupled to the top wall 18 of the housing 12 to enhance coverage of disinfecting an entirety of the interior space 14. The sanitizer 70 may also be positioned within the fans 58 of the thermal control system 44 to sanitize the air emitted into the housing 12. The sanitizer 70 may be positioned within the reservoir 64 to sanitize the water contained therein. The ultra-violet light emitters may also include fluorescent light emitters and blue spectrum light emitters, wherein the fluorescent light emitters and the blue spectrum light emitters may emit light to facilitate the growth of the plant 36 held in each container 32.

A power supply 72 is electrically coupled to the circuit board 54 and typically will comprise a power cord 74 engageable with an electrical outlet. One of the side walls 26 of the pair of side walls 26 may have a generator port 76 and electrically receive a plug from a generator 78, wherein the generator 78 may provide electricity to the power supply 72. A solar panel port 80 may be positioned proximate to the generator port 76 and electrically receive a plug from a solar panel 82, wherein the solar panel 82 may provide electricity to the power supply 72. In an alternative embodiment, the power supply 72 may comprise a rechargeable battery, wherein the battery is rechargeable by connecting a charging cord to the rechargeable battery and to an electricity source. A plurality of wheels 86 is mounted to the bottom wall 16 of the housing 12. The wheels 86 mobilize the housing 12 such that the housing 12 is transportable by rolling upon the wheels 86.

In use, the soil 34 with seeds from the plant 36 is stored within an interior of each container 32. Each container 32 is stored within the interior space 14 of the housing 12. The thermal control system 44 maintains each container 32 at a cooled temperature 84.

The cooled temperature 84 may be adjusted using the actuator 56. The water supply system 60 is programmed by the actuator 56 to supply water to the containers 32 on a reoccurring schedule. The water supply system 60 is configured to recycle water, wherein the water supply system 60 prevents reoccurring refill of the reservoir 64. The sanitizer 70 is programmed to regularly disinfect the interior space 14 of the housing 12 to eliminate bacteria from contaminating the plants 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A refrigerated nursery configured for facilitating growing plants by simulating a selectable cold climate, said refrigerated nursery comprising:
a housing enclosing an interior space and including a bottom wall, a top wall, and a perimeter wall extending between said bottom wall and said top wall;
a plurality of containers being removably stored within said interior space of said housing, each container of said plurality of containers being configured for removably receiving soil for a plant;
a thermal control system being in thermal communication with each of the containers, said thermal control system cooling each container to facilitate growing the plant of each container in a cooled environment;
a circuit board being electrically coupled to said thermal control system;
an actuator being electrically coupled to said circuit board and being engageable by a user to actuate said thermal control system;
a plurality of fans being electrically coupled to said circuit board, said fans facilitating the cooling of said each container of said plurality of containers by circulating cooled air;
a water supply system being in fluid communication with said plurality of containers, wherein said water supply system supplies water to the soil of each container;
a sanitizer being electrically coupled to said circuit board and being actuated to disinfect said interior space of said housing;
a power supply being electrically coupled to said circuit board; and
a plurality of wheels being mounted to said bottom wall of said housing.

2. The refrigerated nursery of claim 1, wherein said perimeter wall includes a first wall, a second wall, and a pair of side walls.

3. The refrigerated nursery of claim 1, further including a shelf being spaced between said top and bottom walls and being positioned lateral relative to said housing, said shelf being perforated with holes to allow water to pass therethrough.

4. The refrigerated nursery of claim 3, wherein said plurality of containers is positioned on said shelf of said housing, each container being perforated with apertures for allowing fluid to pass through each container.

5. The refrigerated nursery of claim 1, wherein each container includes an exterior tube and an interior bucket being removably nested within said exterior tube.

6. The refrigerated nursery of claim 2, wherein each side wall of said pair of side walls has at least one of said fans attached thereto, said fans being in fluid communication with said thermal control system such that said fans provide cooled air to said thermal control system to remove heat.

7. The refrigerated nursery of claim 2, wherein said water supply system includes a plurality of sprinklers providing water downwardly to the containers to facilitate growing of the plants, said sprinklers being coupled to said top wall of said housing.

8. The refrigerated nursery of claim 7, further including a reservoir being positioned between said bottom wall and said shelf of said housing.

9. The refrigerated nursery of claim 8, further including a pump being electrically coupled to said circuit board and being fluidly coupled to said reservoir and to said sprinklers, wherein said pump is actuated to bring water from said reservoir to said sprinklers, said pump being mounted to said bottom wall within said housing.

10. The refrigerated nursery of claim 9, further including a filter being coupled to said pump and filtering said water from said pump.

11. The refrigerated nursery of claim 8, further including a water heater system being in fluid communication with said water supply system, said water heater system including a heat pump compressor being in fluid communication with said reservoir of said water supply system, wherein said heat pump compressor emits heated air into said reservoir to heat water contained within said reservoir.

12. The refrigerated nursery of claim 1, wherein said sanitizer comprises a plurality of ultra-violet light emitters emitting ultra-violet light when actuated, said sanitizer being coupled to said top wall of said housing.

13. The refrigerated nursery of claim 1, wherein said power supply comprises a power cord engageable with an electrical outlet.

14. A refrigerated nursery configured for facilitating growing plants by simulating a selectable cold climate, said refrigerated nursery comprising:
a housing enclosing an interior space and including a bottom wall, a top wall, and a perimeter wall extending between said bottom wall and said top wall, said perimeter wall including a first wall, a second wall, and a pair of side walls, a shelf being spaced between said top and bottom walls and being positioned lateral relative to said housing, said shelf being perforated with holes to allow water to pass therethrough;
a plurality of containers being removably stored within said interior space of said housing, said plurality of containers being positioned on said shelf of said housing, each container of said plurality of containers being configured for removably receiving soil for a plant, each container being perforated with apertures for allowing fluid to pass through each container, each container including an exterior tube and an interior bucket being removably nested within said exterior tube;
a thermal control system being in thermal communication with each of the containers, said thermal control system cooling each container to facilitate growing the plant of each container in a cooled environment;
a circuit board being electrically coupled to said thermal control system;
an actuator being electrically coupled to said circuit board and being engageable by a user to actuate said thermal control system;
a plurality of fans being electrically coupled to said circuit board, said fans facilitating the cooling of said each container of said plurality of containers by circulating cooled air, each side wall of said pair of side walls having at least one of said fans attached thereto, said fans being in fluid communication with said thermal control system such that said fans provide cooled air to said thermal control system to remove heat;
a water supply system being in fluid communication with said plurality of containers, wherein said water supply system supplies water to the soil of each container, said water supply system including:
a plurality of sprinklers providing water downwardly to the containers to facilitate growing of the plants, said sprinklers being coupled to said top wall of said housing;
a reservoir being positioned between said bottom wall and said shelf of said housing;
a pump being electrically coupled to said circuit board and being fluidly coupled to said reservoir and to said sprinklers, wherein said pump is actuated to bring water from said reservoir to said sprinklers, said pump being mounted to said bottom wall within said housing;
a filter being coupled to said pump and filtering said water from said pump;
a water heater system being in fluid communication with said water supply system, said water heater system including a heat pump compressor being in fluid communication with said reservoir of said water supply system, wherein said heat pump compressor emits heated air into said reservoir to heat water contained within said reservoir;
a sanitizer being electrically coupled to said circuit board and being actuated to disinfect said interior space of said housing, said sanitizer comprising a plurality of ultra-violet light emitters emitting ultra-violet light when actuated, said sanitizer being coupled to said top wall of said housing;
a power supply being electrically coupled to said circuit board, said power supply comprising a power cord engageable with an electrical outlet; and
a plurality of wheels being mounted to said bottom wall of said housing.
